(19) United States
(12) Patent Application Publication
(10) Pub. No.: US 2004/0211132 A1
(43) Pub. Date: Oct. 28, 2004

(54) Compressible frame guard device for a window or door

(76) Inventors: Gabriel Petta, Woodbridge (CA); Rolf Joseph Ohrstrom, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/736,623

(22) Filed: Dec. 17, 2003

Related U.S. Application Data
(60) Provisional application No. 60/464,642, filed on Apr. 23, 2003.

(51) Int. Cl. E06B 1/04

(52) U.S. Cl. 52/204.1; 52/205

(57) ABSTRACT

In the combination of a frame guard device and the frame of a window or door, wherein the window or door is fitted in a wall having an exterior wall layer with a sill, the frame has a lower horizontal member adjacent the sill. The device has a base extending from the lower horizontal member of the frame and a compressive member extending from the base, and the compressive member has a datum surface disposed between the lower horizontal member of the frame and the sill. The distance between the base and the datum surface defines a force-absorbing zone.

### FIELD OF THE INVENTION

This invention relates to a compressible frame guard device for a window or door.

### BACKGROUND OF THE INVENTION

Windows and doors are commonly installed in the exterior walls of buildings, wherein the walls have an interior support structure, which is typically constructed of wood, and an exterior layer, which may be brick or stone. The window is typically fixed to the interior support structure of the wall prior to installation of the exterior layer. The frame of the window is typically positioned to extend outward of the interior support structure of the wall, so that a portion of the frame of the window protrudes through an opening provided in the exterior layer of the wall.

Over time, the entire wall (interior support structure and exterior layer) may be expected to settle as the foundation of the house settles. In addition, the interior support structure can be expected to shift vertically downwards relative to the foundation, so that the frame of the window or door shifts vertically downwards. This downward shift is frequently the result of shrinkage of the various members (e.g., wood) used to construct the interior support structure.

For example, an interior support structure may be constructed of wooden joists and studs. The wood used will generally dry over time, causing the studs and joists to shrink in cross-sectional width. Accordingly, the shrinkage of any horizontal studs and joists can cause a corresponding decrease in the overall height of the wall. Typical wall construction includes a horizontal sill plate between the foundation and the lower end of the interior structure, horizontal floor joists between floors of the building, and horizontal studs in the wall structure above and below the floor joists. Adding the shrinkage of all of the horizontal elements together, the overall decrease in height of the interior structure is obtained. In general, for a two-story home, the vertical decrease in height of the interior support structure would not be expected to exceed two inches.

In contrast, the exterior layer of the wall does not generally shrink over time. An outer wall constructed of brick, for example, generally has its base resting directly on the foundation of the building (for example, on the footing of a poured concrete basement wall). The overall height of the exterior layer relative to the foundation does not, therefore, generally decrease over time.

Accordingly, over time, the interior support structure can be expected to shift downward relative to the exterior layer of the wall. Since the frames of windows and doors typically project outwards from the interior support structure through an opening in the exterior layer of the wall, it is desirable that, below the frame of windows and doors, a gap exists between the lower surface of the frame and the adjacent uppermost surface of the exterior layer of the wall. Such a gap can ensure that, as the interior support structure of the wall shrinks and shifts downwards, the frame of the window or door is free to move downwards relative to the exterior layer of the wall.

According to known frames and installation techniques, however, this gap is frequently omitted or is insufficient in size. Where an insufficient gap is provided, the outermost portion of the frame of the window can catch the exterior layer of the wall when the interior structural frame shifts vertically downward over time. This can cause problems with opening or closing the window, and may compromise any weather-proof sealing provided around the frame 12 of the window.

These problems can conveniently be overcome by using a compressible frame guard device in accordance with the present invention. In particular, the device can be advantageously provided adjacent the frame of a window or door, to protect the frame against distortional forces exerted by interference between the frame and an adjacent exterior wall layer.

### SUMMARY OF THE INVENTION

The present invention provides a compressible frame guard device for protecting a frame for a window or door from distortional forces that may result from interference between the frame and an exterior layer of a wall.

According to a first aspect of the invention, a frame guard device in combination with a frame of a window or door is provided. The frame of the window or door is fitted in a wall having an exterior wall layer with a sill, the frame having a lower horizontal member adjacent the sill. The device comprises a base extending from the lower horizontal member of the frame and a compressive member extending from the base, the compressive member having a datum surface disposed between the lower horizontal member of the frame and the sill, the distance between the base and the datum surface defining a force-absorbing zone wherein the compressible member is compressible over the force-absorbing zone between an expanded state and a compressed state.

In one embodiment, the compressive member comprises a strip of pliable material extending downwardly at an incline to the vertical, wherein the strip is generally pivotable about an axis disposed along an edge of the compressive member adjacent the base. Furthermore, a portion of the compressive member opposite the base is bent upwards away from the sill.

As well, in one embodiment the device is attachable to the frame, the device having attachment clips extending from the base, and the frame having corresponding recesses for snappingly receiving the clips.

In another embodiment, the device and the frame comprise a single unitary structure, and the device further comprises a break-away panel extending between the compressible member and the frame.

### BRIEF DESCRIPTION OF THE DRAWINGS

For a better understanding of the present invention and to show more clearly how it would be carried into effect, reference will now be made by way of example, to the accompanying drawings that show a preferred embodiment of the present invention, and in which:

FIG. 1 is a side view in cross-section of a window frame installed in a wall in accordance with the prior art;

FIG. 2 is a perspective view of an embodiment of a compressible frame guard device in accordance with the present invention, shown in combination with a frame for a window or door installed in a wall;

FIG. 3 is an enlarged perspective view of the device of FIG. 2;

FIGS. 4 and 5 are side views in cross-section of the device of FIG. 1, shown before and after vertical shifting of the frame, respectively;

FIGS. 4a and 5a are enlarged views of portions of FIGS. 4 and 5, respectively;

FIGS. 6 and 7 are side views in cross-section of an alternative embodiment of the device of a compressible frame guard device in accordance with the present invention, shown in combination with a frame for a window or door installed in a wall; and

FIGS. 6a and 7a are enlarged views of portions of FIGS. 6 and 7, respectively.

### DETAILED DESCRIPTION OF THE INVENTION

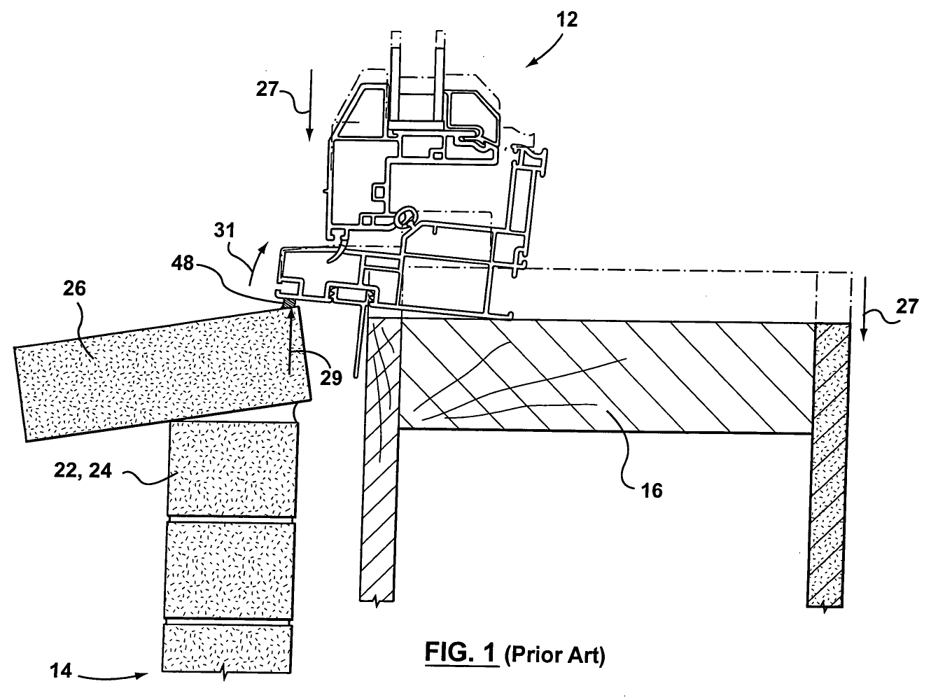

Referring to FIG. 1, a frame 12 for a window or a door is provided in a wall 14, in accordance with the prior art. The frame 12 is mounted to an interior wooden support structure 16 of the wall 14 and is positioned to extend over top of a sill 26 provided in an exterior wall layer 22 constructed of bricks 24. Little or no space is provided between the upper surface of the sill 26 and the lower surface of the frame 12.

As the interior wall structure 16 shifts downwards (shown by arrow 27) relative to the exterior wall layer 22 and the sill 26, the frame 12 moves downward toward the sill 26. This can result in interference between the window frame 12 and the sill 26, creating an upward force (arrow 29) on the frame 12. The upward force 29 can distort or twist the frame 12 (arrow 31), causing problems with opening or closing the window, and compromising any weather-proof sealing provided around the frame 12 of the window.

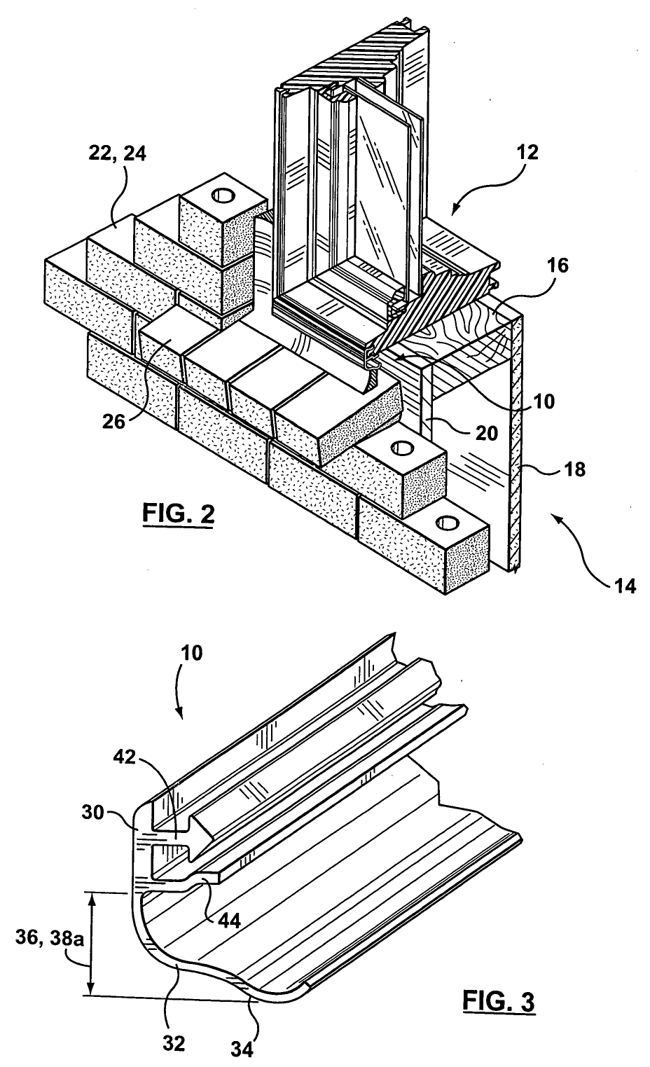

A compressible frame guard device according to the present invention is shown generally in FIG. 2 at reference character 10. In FIG. 2, the device 10 is shown in combination with a frame 12 for a window or a door, which is provided in a wall 14. The wall 14 has an interior support structure 16, to which may be attached interior panels, such as drywall 18, and exterior panels, such as sheathing 20.

Adjacent the outer sheathing 20, the wall 14 can be provided with an exterior wall layer 22. In the embodiment illustrated, the exterior wall layer 22 comprises courses of bricks 24. A sill 26, also of bricks, is provided within the outer wall layer 22 of the wall 14, below the frame 12. The sill 26 typically extends outward from the wall 14, at a downward incline from horizontal.

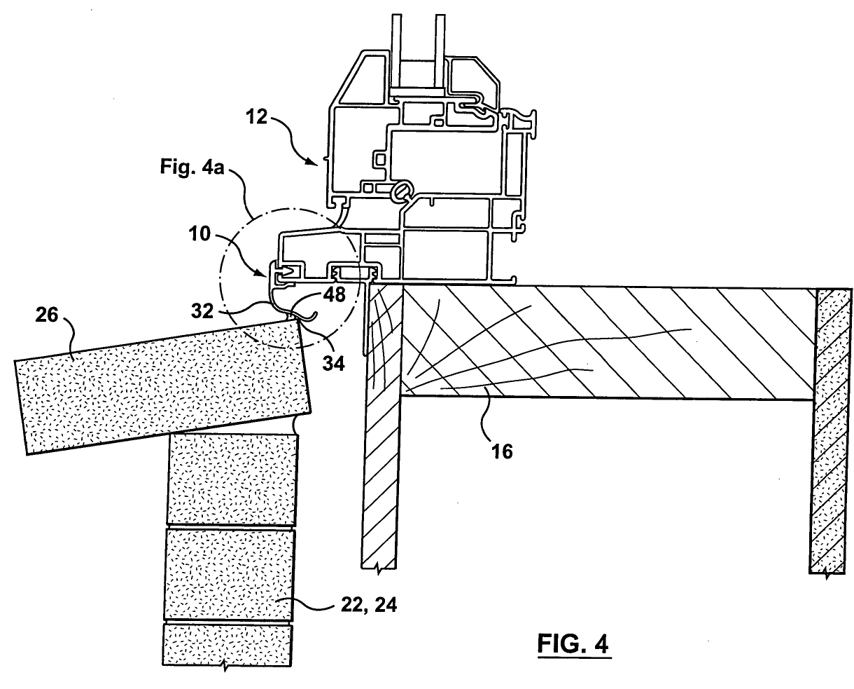

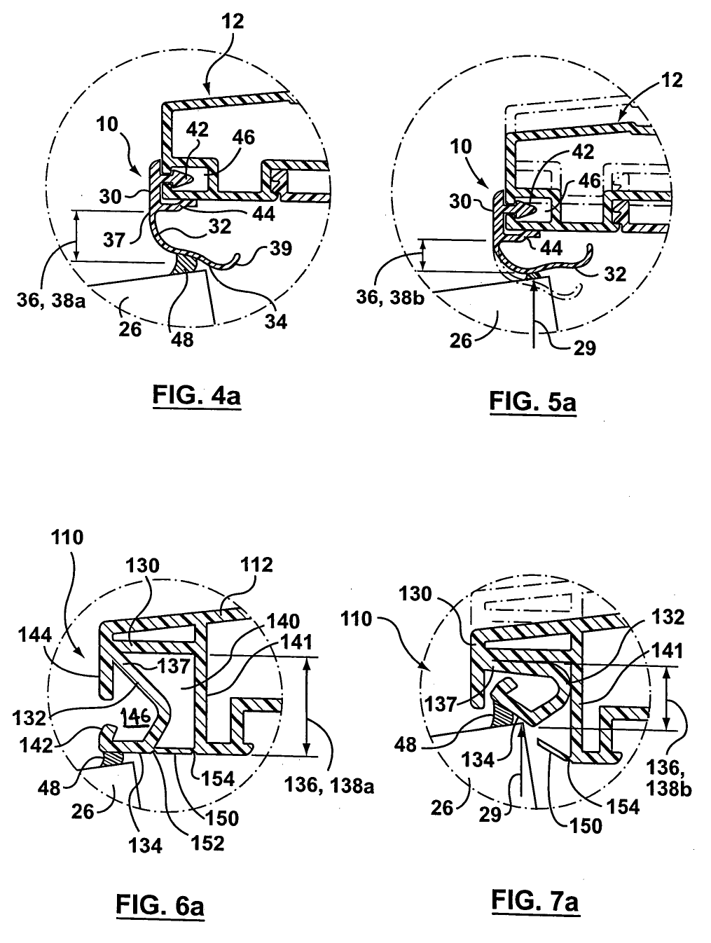

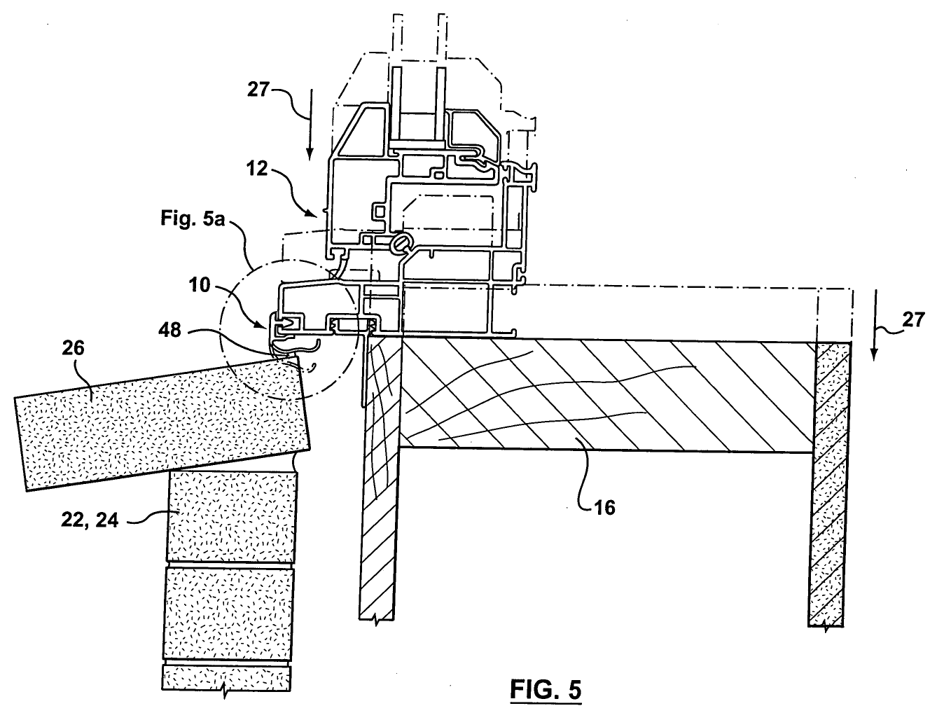

As best seen in FIG. 3, the device 10 in the embodiment illustrated, is an elongate strip like member, having a base 30 and a compressible member 32, which extends from the base 30. The compressible member 32 provides a lower datum or contact surface 34 adjacent an uppermost surface of the sill 26, directly below the frame 12 (FIG. 4). The contact surface 34 is spaced away from the base 30 to provide a force-absorbing zone 36 (see also FIG. 4a) between the base 30 and the lower contact surface 34 of the compressible frame guard device 10.

The force-absorbing zone 36 serves to protect the frame 12 by absorbing any upward force 29 which can result from interference between the frame 12 and the sill 26 as the interior support structure 16 of the wall 14 shrinks and settles downwardly. When shifting downwardly, once the surface 34 of the compressible member 32 bears against the sill 26, further downward shifting of the frame 12 will cause the space between the surface 34 and the base 30 of the device 10 to decrease. In other words, the compressible member 32 is reducible over the force-absorbing zone 36 from an expanded state having a vertical height 38a (FIG. 4a), to a compressed state having a vertical height 38b (FIG. 5a). Compression of the compressible member 32 over the force-absorbing zone 36 from the expanded state to the compressed state can be effected under a sufficiently low load or force to ensure that any potentially damaging forces are absorbed by the compression of the compressible member 32, rather than being transferred through the device 10 to the frame 12.

In the embodiment illustrated, the compressible member 32 of the device 10 comprises a pliable strip 32 which can deform or deflect under a vertical load. The pliable strip 32 extends from the base 30 of the device 10 so as to be generally inclined from the vertical when installed for use. The strip 32 extends from the base 30 generally along the upper horizontal edge 37. Away from the edge 37, the strip 32 may be bent or curved upwardly, to provide a ramp portion 39.

In the embodiment illustrated, the device 10 also comprises mechanical attachment means extending from the base 30 for attaching the device 10 to the frame 12. In particular, the device 10 is provided with upper and lower attachment tabs 42, 44, which are shaped to cooperate in a snap-fit arrangement with a recess 46 provided in the frame 12 (FIG. 4a).

In use (FIG. 4), the collapsible frame guard device 10 is provided along the lower edge of the frame 12, generally prior to construction of the exterior wall layer 22. The lower contact surface 34 of the device 10 provides a gauge line or datum that can be used for measuring the required height of the wall 14 below the frame 12. In the case of a brick wall, the bricklayer can determine the number of courses of bricks and the approximate thickness of mortar that will be required to build up the exterior wall layer 22 to a desired height below the lower contact surface 34 of the device 10. In the embodiment illustrated, where the device 10 is used in a wall 14 having a sill 26, the height of the exterior wall layer 22 should leave sufficient space between the upper end of the exterior wall layer 22 and the surface 34 of the device 10 for the installation of the sill 26, so that installation of the sill 26 does not compress or substantially compress the device 10.

Alternatively, the device 10 could be provided with an enlarged force-absorbing zone 36 having greater vertical difference between the expanded (uncompressed) height 38a and the compressed height 38b, corresponding to the combined vertical distance of the expected downward shift of the frame 12 and the partial or total vertical height of the sill 26. Accordingly, such a modified force-absorbing zone could allow the compressible member 32 to be partially compressed to permit installation of the sill 26 below the device 10, while maintaining sufficient residual compressibility to accommodate downward shifting of the frame 12 over time.

In either case, once the sill 26 has been installed, the device 10 presents a surface adjacent the exterior wall layer 22 to which a bead of caulking 48 can conveniently be applied. In the embodiment illustrated, the bead of caulking 48 extends alongside the lower surface 34 of the strip 32, to seal the interface between the device 10 and the sill 26.

Referring to FIG. 5, as the inner wall 16 settles and shrinks over time, the inner wall 16 and the frame 12 which is mounted to the inner wall 16 will shift vertically downwards relative to the exterior wall layer 22 and sill 26 (arrow 27). As the frame 12 shifts downward, the strip 32 of the device 10 may bear against the sill 26, generating an upward force 29 along or near the surface 34 of the strip 32 (FIG. 5a). This upward force can cause the strip 32 to deform or deflect upward, generally by pivoting or bending about the upper edge 37 of the strip 32. Accordingly, the surface 34 is pushed upwards towards the base 30 of the device 10, and the compressible member 32 is moved over the force-absorbing zone 36 from its expanded state (having vertical height 38a) towards its compressed state (having vertical height 38b).

It may be that as the vertical distance between the base 30 of the device 10 and the sill 26 of the wall 14 decreases, the uppermost surface of the sill 26 will tend to drag or slide along the adjacent surface of the strip 32, in a direction from the ramp portion 39 towards the upper edge 37 (FIGS. 4a and 5a). The ramp portion 39 can facilitate the relative sliding action between the sill 26 and the strip 32 by guiding the strip over the surface of the sill 26, thereby preventing buckling or crumpling of the strip 32. This guiding action of the ramp portion 39 may be particularly advantageous in cases where, at the initial (un-shifted) position of the frame 12 (FIG. 4a), the uppermost surface of the sill 26 is nearer to the interior support structure 16 than is the surface 34 of the strip 32 (in other words, in cases where the sill 26 is further to the right than depicted in FIG. 4a).

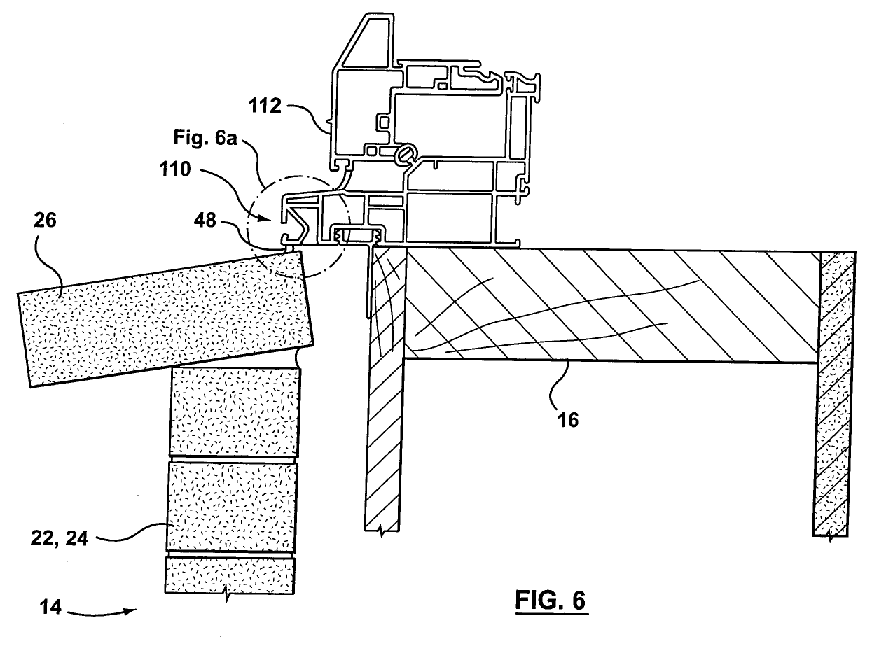

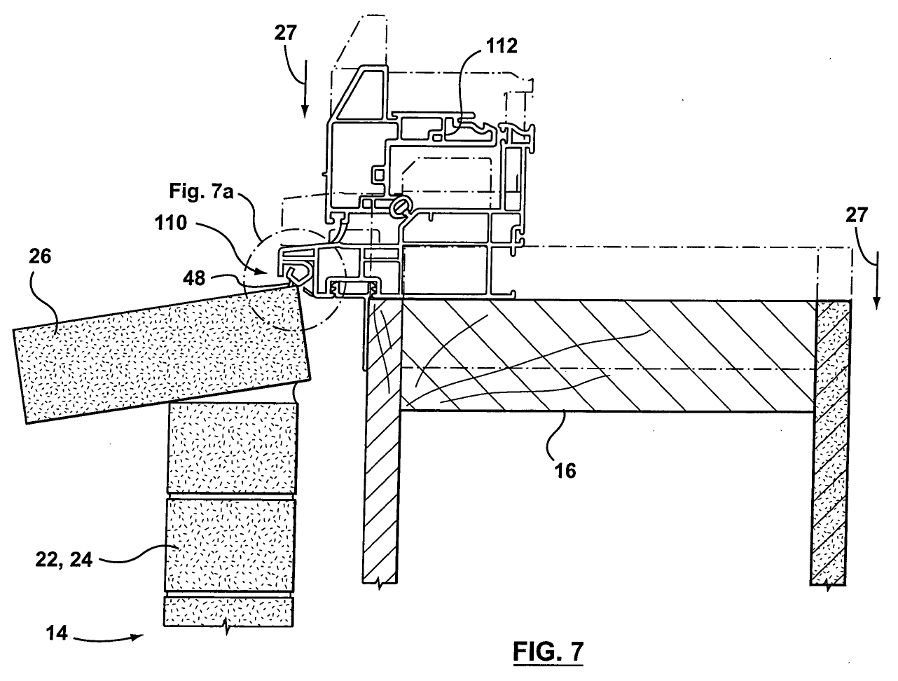

An alternative embodiment of a frame guard device according to the present invention is shown generally at 110 in FIG. 6. The device 100 is similar to the device 10, and elements of the alternative frame guard device 110 which correspond to the device 10 are given the same reference characters as the device 10, incremented by 100.

In FIGS. 6 and 7, the frame guard device 110 is shown in combination with a modified frame 112 for a window or door, installed in a wall 14 having an interior support structure 16 and an exterior wall layer 22. The device 110 is integrally formed with a lower horizontal member of the frame 112, so that the frame 112 and the device 110 provide a single, unitary structure. This advantageously eliminates the need to separately construct the device 110 and to then attach it to a frame of a window or door.

The device 110 extends generally along the lower edge of the frame 112, at a position vertically above the uppermost portion of the sill 26 provided in the exterior wall layer 22. More particularly, in the embodiment illustrated (FIG. 6a), a lower horizontal member of the frame 112 is provided with a housing 140, having an upper horizontal surface providing a base 130 of the device 110, and a generally vertical back wall 141 disposed between the cavity 140 and the main body of the frame 112. A compressible member 132 extends from the base 130, the compressible member 132 comprising a strip of pliable material having an upper edge 137 adjacent the base 130 and a terminating edge 142 opposite the upper edge 137.

In the device 110, an upper portion of the strip 132 extends downward and at an incline towards the back wall 141 of the cavity 140, and a lower portion of the strip 32 extends downward but at an incline away from the back wall 141 of the cavity 140. The lowermost portion of the strip 132 extends substantially horizontally away form the back wall 141, and provides the lower datum or contact surface 134 of the device 110. Sufficient space is provided between the strip 132 and the adjacent elements of the frame 112 so that the strip 132 can move to its compressed state without interference, as described hereinafter.

Referring to FIGS. 7 and 7a, the device 110 can compress in response to an upward vertical force 29 exerted on the lower surface 134 of the strip 132. The force 29 can be caused by, for example, but not limited to, downward vertical shifting of the frame 12 relative to the exterior wall layer 22 caused by shrinking and settling of the interior wall support structure 16 over time. The compressible member 132 of the device 110 can compress over the force-absorbing zone 136 from an expanded height 138a to a compressed height 138b.

During compression of the device 110, the strip 132 can pivot or bend about the upper edge 137 of the strip 132 in response to the upward movement of the surface 134 relative to the base 130. The strip 132 can also bend in additional locations, such as the transition point between the upper and lower portions of the strip 132, which can advantageously provide a relatively large compressibility distance (the difference between 138a and 138b) in a compact space.

The device 110 in combination with the frame 112 may optionally provide an attachment recess 146 along the edge of the frame 112. In particular, the terminal edge 142 of the strip 132 may extend in a generally vertical upward direction to form a lower retaining lip, and an opposed upper retaining lip 144 may extend downward from the base 130. The attachment recess 146 (having the opposed retaining lips 142, 144) can be used to receive, for example, but not limited to, attachment tabs of a join cap or coupler for joining two window frames side-by-side. In such an application, the frame 112 may have another frame joined beneath it, rather than having a sill directly beneath the frame 112.

Furthermore, a break-away panel 150 can be provided between the interior edge of the surface 134 and the back wall 141 of the cavity 140, generally in coplanar relationship with the surface 134. The break-away panel 150 can be a wall of material which is integrally moulded with the frame 112, and has localized thinned seams or break lines 152, 154 extending along either edge of the break-away panel 150.

Under a transverse load, such as vertical force 29 (FIG. 7a), the panel 150 can break free from the frame 112 along either of the break lines 152, 154 for permitting compression of the compressible member over the force-absorbing zone 136 as described previously.

In the absence of a vertical force (FIG. 6a), the break-away panel 150 can strengthen and support the lower retaining lip 142 which can be advantageous, particularly when the attachment recess 146 is being used. Also, the break-away panel 150 can serve to keep debris out of the cavity 140, and particularly from between the strip 132 and the back wall 141, where debris could interfere with proper compression of the device 110. Furthermore, the panel 150 can serve as a useful visual indicator regarding the condition of the compressible frame guard device 110. More particularly, a frame 112 having a panel 150 intact could be considered to have the full compressibility distance available for protecting the frame 112. In cases where the panel 150 is no longer intact but has separated along a break line 152, 154, it may be that the frame 112 was damaged in shipping or was pre-compressed by improper installation of the sill 26.

It is to be understood that what has been described are preferred embodiments of the invention. The invention nonetheless is susceptible to certain changes and alternative embodiments without departing from the subject invention, the scope of which is defined in the following claims.

1. In combination, a frame guard device and a frame of a window or door, wherein the frame of the window or door is fitted in a wall having an exterior wall layer with a sill, the frame having a lower horizontal member adjacent the sill, the device comprising:
a) a base extending from the lower horizontal member of the frame; and
b) a compressive member extending from the base, the compressive member having a datum surface disposed between the lower horizontal member of the frame and the sill, the distance between the base and the datum surface defining a force-absorbing zone.

2. The combination of claim 1 wherein the compressive member comprises a strip of pliable material.

3. The combination of claim 2 wherein the strip extends downwardly at an incline to the vertical.

4. The combination of claim 2 wherein the compressive member is generally pivotable about an axis disposed along an edge of the compressive member adjacent the base.

5. The combination of claim 3 wherein a portion of the compressive member opposite the base is bent upwards away from the sill.

6. The combination of claim 1 wherein the device is attachable to the frame.

7. The combination of claim 6 wherein the device has an attachment clip extending from the base, and the frame has a corresponding recess for engaging the clip in a snap-fit arrangement.

8. The combination of claim 1 wherein the device and the frame comprise a single unitary structure.

9. The combination of claim 8 wherein the device further comprises a break-away panel extending between the compressible member and the frame.

10. A compressible frame guard device for the frame of a window or door fitted in a wall, the wall having an exterior wall layer with a sill, the device comprising:
a) a base extending from the frame adjacent the sill; and
b) a compressive member extending from the base and having a datum surface disposed between the base and the sill.

11. The device of claim 10 wherein the compressive member comprises a strip of pliable material.

12. The device of claim 11 wherein the strip extends downwardly at an incline to the vertical.

13. The device of claim 12 wherein the compressive member is generally pivotable about an axis disposed along the compressive member adjacent the base.

14. The device of claim 13 wherein a portion of the compressive member opposite the base is bent upwards away from the sill.

15. The device of claim 10 wherein the device is attachable to the frame.

16. The device of claim 15 further comprising attachment clips extending from the base, the clips being shaped to snappingly engage an attachment recess provided in the frame.

17. The device of claim 10 wherein the device is integrally moulded with a frame for a window or door to form a single unitary structure.

18. The device of claim 17 wherein the device further comprises a break-away panel extending between the compressible member and an adjacent element of a frame for a window or door.
